(19) United States
(12) Patent Application Publication
(10) Pub. No.: US 2019/0235594 A1
(43) Pub. Date: Aug. 1, 2019

(54) INFORMATION PROCESSING SYSTEM AND POWER SUPPLY STATE CONTROLLING METHOD

(71) Applicant: Kei SENBA, Saitama (JP)

(72) Inventor: Kei SENBA, Saitama (JP)

(73) Assignee: Ricoh Company, Ltd., Tokyo (JP)

(21) Appl. No.: 16/203,824

(22) Filed: Nov. 29, 2018

(30) Foreign Application Priority Data
Jan. 30, 2018 (JP) 2018-014179

(51) Int. Cl. G06F 1/26; G06F 1/3203; H02J 50/80

(52) U.S. Cl. CPC G06F 1/266; G06F 1/263; H02J 50/80; G06F 1/3203

(57) ABSTRACT

An information processing system includes an information processing apparatus and an operation device attachable to and detachable from the information processing apparatus. The operation device includes a sensor and first circuitry. The sensor detects a physical change of the operation device. The first circuitry transmits a request for state transition to the information processing apparatus when the physical change of the operation device is detected by the sensor. The information processing apparatus includes second circuitry that acquires the request for state transition, and switches a power supply state of the information processing apparatus.

### CROSS-REFERENCE TO RELATED APPLICATION

This patent application is based on and claims priority pursuant to 35 U.S.C. § 119(a) to Japanese Patent Application No. 2018-014179 filed on Jan. 30, 2018, in the Japan Patent Office, the entire disclosure of which is hereby incorporated by reference herein.

### BACKGROUND

### Technical Field

The present invention relates to an information processing system and a power supply state controlling method.

### Description of the Related Art

Due to environmental regulations and increased awareness of the issue of environmental burdens, information processing apparatuses in general are expected to reduce power consumption. Existing information processing apparatuses equipped with an image processing function, such as a printer, a copier, a facsimile machine, and a multifunction peripheral, are equipped with an energy saving function. Due to an increasing demand for the energy saving function, information processing apparatuses that reduce power consumption during operation thereof or in energy saving mode tend to be purchased, and a demand for further improvement of the energy saving function is expected to continue to grow.

### SUMMARY

In one embodiment of this invention, there is provided an improved information processing system that includes, for example, an information processing apparatus and an operation device attachable to and detachable from the information processing apparatus. The operation device includes a sensor and first circuitry. The sensor detects a physical change of the operation device. The first circuitry transmits a request for state transition to the information processing apparatus when the physical change of the operation device is detected by the sensor. The information processing apparatus includes second circuitry that acquires the request for state transition, and switches a power supply state of the information processing apparatus.

In one embodiment of this invention, there is provided an improved information processing system that includes, for example, an information processing apparatus and an operation device attachable to and detachable from the information processing apparatus. The operation device includes a sensor and first circuitry. The sensor detects an electrical change of the operation device. The first circuitry transmits a request for state transition to the information processing apparatus when the electrical change of the operation device is detected by the sensor. The information processing apparatus includes second circuitry that acquires the request for state transition, and switches a power supply state of the information processing apparatus.

In one embodiment of this invention, there is provided an improved power supply state controlling method performed by an information processing system including an information processing apparatus and an operation device attachable to and detachable from the information processing apparatus. The power supply state controlling method includes, for example, detecting a physical or electrical change of the operation device, transmitting a request for state transition from the operation device to the information processing apparatus when the physical or electrical change of the operation device is detected, and switching a power supply state of the information processing apparatus in response to the request for state transition.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is an exemplary diagram illustrating an overview of an operation of an image forming apparatus according to an embodiment of the present invention;

FIG. 2 is a diagram illustrating an exemplary hardware configuration of the image forming apparatus;

FIG. 3 is an exemplary functional block diagram illustrating functions of the image forming apparatus in blocks;

FIG. 4 is an exemplary diagram illustrating transitions of the state of a main unit of the image forming apparatus;

FIG. 5 is an exemplary flowchart illustrating an operation related to control of returning the image forming apparatus from an energy saving state;

FIG. 6 is an exemplary flowchart illustrating an operation related to control of transitioning the image forming apparatus to the energy saving state;

FIG. 7 is an exemplary flowchart illustrating an operation related to control of shutting down power supply to the image forming apparatus;

FIG. 8 is an exemplary flowchart illustrating an operation related to the control of returning the image forming apparatus from the energy saving state;

FIG. 9 is an exemplary flowchart illustrating an operation related to the control of transitioning the image forming apparatus to the energy saving state; and

FIG. 10 is an exemplary flowchart illustrating an operation related to the control of shutting down power supply to the image forming apparatus.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As well as a request for improvement of an energy saving function, there has recently been a request for making an operation panel (i.e., operation device) of an information processing apparatus portable to remote-control the information processing apparatus, and there is an existing technique addressing this request.

According to the existing technique, however, power control of a main unit of the information processing apparatus may not be executed, depending on the state of the operation device attachable to and detachable from the information processing apparatus. More specifically, according to the existing technique, when the information processing apparatus is used with the operation device detached from the main unit of the information processing apparatus and held in a hand of a user at a place away from the main unit of the information processing apparatus, the operation device is unable to transition the main unit of the information processing apparatus from an energy saving state to a standby state. Further, when the operation device at the place away from the main unit of the information processing apparatus is not being operated, the main unit of the information processing apparatus is unable to detect the non-operating state of the operation device and transition from the standby state to the energy saving state or transition from the energy saving state to automatically shut down. The existing technique is therefore open to improvement of operability and usability in terms of control of returning the main unit of the information processing apparatus from the energy saving state, control of transitioning the main unit of the information processing apparatus to the energy saving state, and control of automatically shutting down power supply to the main unit of the information processing apparatus.

An information processing apparatus according to an embodiment of the present invention described below is capable of performing power control of a main unit of the information processing apparatus in accordance with the state of an operation device attachable to and detachable from the information processing apparatus.

As an embodiment for implementing the present invention, a power supply state controlling method performed by an image forming apparatus (i.e., information processing apparatus) will be described below with reference to the drawings.

An overview of the image forming apparatus will first be described.

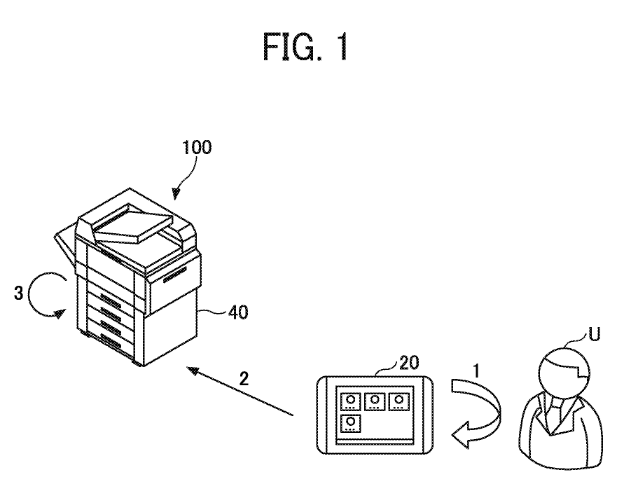

FIG. 1 is an exemplary diagram illustrating an overview of an operation of an image forming apparatus 100 of the embodiment. The image forming apparatus 100 includes a main unit 40 and an operation device 20 attachable to and detachable from the image forming apparatus 100. A user U operates the operation device 20 at a place away from the main unit 40 of the image forming apparatus 100. The operation device 20 and the main unit 40 are capable of wirelessly communicating with each other.

As indicated by arrow 1, the operation device 20 detects a physical change caused when the user U holds the operation device 20 to operate the operation device 20. The operation device 20 is equipped with, for example, an angular velocity sensor capable of detecting the tilt of the operation device 20. When the user U holds the operation device 20, the angular velocity sensor detects the tilt angle of the operation device 20.

As indicated by arrow 2, the operation device 20 determines, based on the physical change, whether or not the user U is to use the main unit 40 of the image forming apparatus 100 via the operation device 20 held in a hand of the user U. If having determined that the user U is to use the main unit 40 of the image forming apparatus 100, the operation device 20 transmits an energy saving state cancellation request to the image forming apparatus 100.

As indicated by arrow 3, based on the energy saving state cancellation request received from the operation device 20, the main unit 40 of the image forming apparatus 100 returns (i.e., transitions) the state thereof to a standby state from an energy saving state.

As well as the energy saving state cancellation control described with FIG. 1, if the operation device 20 determines, from the physical change of the operation device 20 (i.e. a detection signal of the angular velocity sensor), that the user U is not to use the image forming apparatus 100, the operation device 20 transmits an energy saving state transition request to the main unit 40 of the image forming apparatus 100 to transition the main unit 40 of the image forming apparatus 100 to the energy saving state. Similarly, the operation device 20 transmits a power supply shutdown request to the main unit 40 of the image forming apparatus 100 to allow the main unit 40 to perform automatic power supply shutdown.

As described above, even when the image forming apparatus 100 is used with the operation device 20 detached from the image forming apparatus 100 and held in a hand of a user at a place away from the main unit 40 of the image forming apparatus 100, the main unit 40 of the image forming apparatus 100 is easily capable of performing control operations such as the control of returning the main unit 40 of the image forming apparatus 100 from the energy saving state, the control of transitioning the main unit 40 of the image forming apparatus 100 to the energy saving state, and the control of automatically shutting down power supply to the main unit 40 of the image forming apparatus 100 based on the request from the operation device 20, thereby improving operability and usability.

The operation device 20 is also capable of detecting an electrical change caused in the operation device 20 when the user holds the operation device 20 to operate the operation device 20. Specifically, control operations similar to the above-described ones are executable with a capacitance sensor included in the operation device 20, as described in detail later.

Some terms used throughout the specification will be described.

The term “attachable to and detachable from” means that an item may be attached (i.e., installed) to the information processing apparatus (i.e., the image forming apparatus 100 in the present example) or detached from the information processing apparatus. The item may be attached to or detached from the information processing apparatus with or without a tool. Further, when the item is described as “attached” to the information processing apparatus, the item may be simply placed near the information processing apparatus.

The term “physical change” refers to a non-chemical change not involving a change in shape or quality. The term “electrical change” refers to an electrical change detectable in voltage or current, for example. The physical change and the electrical change may not be clearly distinguished from each other.

An example of the configuration of the image forming apparatus 100 will be described.

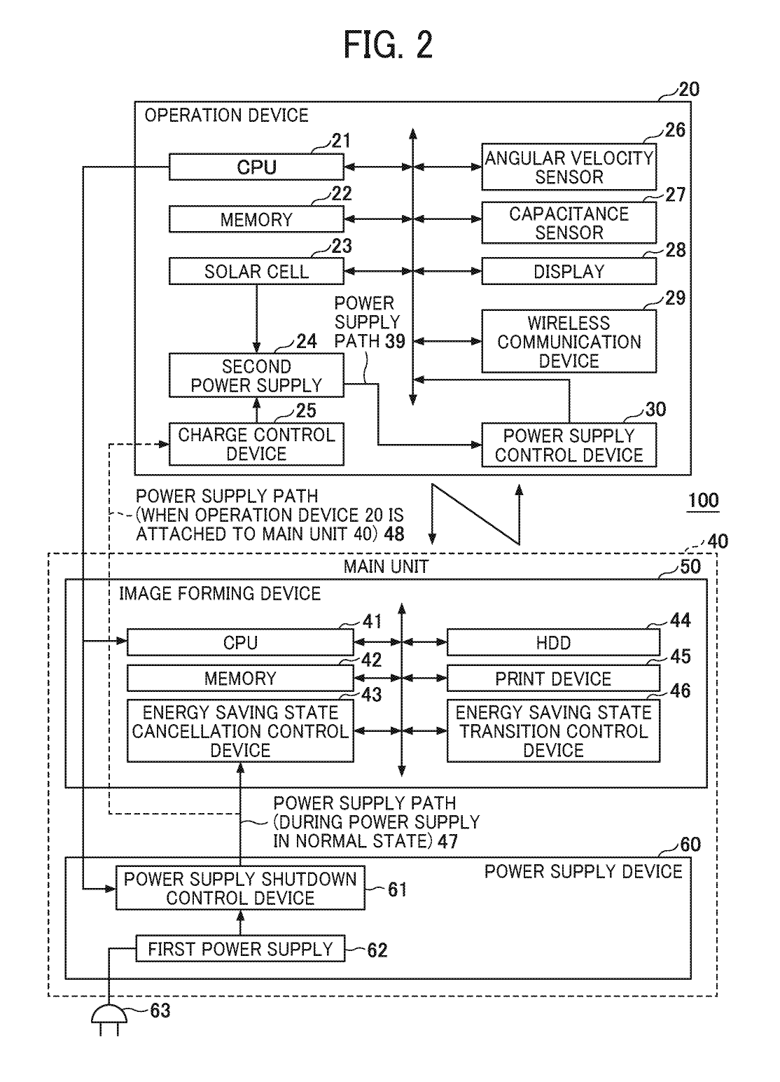

The image forming apparatus 100 is an apparatus having a function of forming an image. As described later with FIG. 2, the image forming apparatus 100 has the function of an information processing apparatus. It suffices if the image forming apparatus 100 of the embodiment has the function of forming an image. The image forming apparatus 100 may be called a printer, a printing apparatus, or a multifunction peripheral. The term “multifunction peripheral” refers to an apparatus with multiple functions, such as a facsimile transmission and reception function, a document scanning function, and a copying function. The multifunction peripheral may be called an MFP, a copier, a copying machine, an all-in-one (AIO) unit, or office equipment, for example.

FIG. 2 is a diagram illustrating an example of the hardware configuration of the image forming apparatus 100. The image forming apparatus 100 includes the operation device 20, an image forming device 50, and a power supply device 60. The image forming device 50 and the power supply device 60 other than the operation device 20 are fixed to the main unit 40 of the image forming apparatus 100, and thus are at least a part of the main unit 40 of the image forming apparatus 100.

The main unit 40 of the image forming apparatus 100 includes an installation space for the operation device 20 to allow the user to install or detach the operation device 20 in or from the main unit 40 of the image forming apparatus 100. The image forming apparatus 100 therefore may be referred to as an image forming system or an information processing system.

When installed in the installation space for the operation device 20, the operation device 20 may communicate with the main unit 40 by wire or wirelessly. When detached from the installation space for the operation device 20, on the other hand, the operation device 20 preferably communicates with the main unit 40 wirelessly. Further, the operation device 20 may communicate with the main unit 40 by using different wireless communication systems between when installed in the installation space for the operation device 20 and when detached from the installation space for the operation device 20.

When installed in the installation space for the operation device 20, the operation device 20 is connected to the main unit 40 via a power supply path 48 to charge a second power supply 24 with power supplied from the power supply device 60. When the operation device 20 installed in the installation space for the operation device 20 communicates with the main unit 40 by wire, the power supply path 48 may also be used as a communication line.

The operation device 20 includes hardware components including a central processing unit (CPU) 21, a memory 22, a solar cell 23, the second power supply 24, a charge control device 25, an angular velocity sensor 26, a capacitance sensor 27, a display 28, a wireless communication device 29, and a power supply control device 30. The CPU 21 executes programs stored in the memory 22 to provide an overall function of the operation device 20 in cooperation with the other hardware components of the operation device 20 illustrated in FIG. 2. The CPU 21 may be called a microprocessor, a central processing unit, or a microcomputer, for example.

The memory 22 stores data such as the data of a screen displayed on the display 28 of the operation device 20 and data temporarily used in data processing by the CPU 21. The memory 22 further stores the programs executed by the CPU 21. FIG. 2 illustrates one memory 22, but the operation device 20 may include two types of memories: a volatile memory and a non-volatile memory.

The solar cell 23 generates power from external light, which includes sunlight and fluorescent light. The second power supply 24 is, for example, a secondary battery that stores the power generated by the solar cell 23 and supplies direct-current power to the operation device 20. When the operation device 20 is attached to the main unit 40 of the image forming apparatus 100, the charge control device 25 controls charging of the second power supply 24 of the operation device 20 with the power transmitted from a first power supply 62 of the power supply device 60 via the power supply path 48.

The angular velocity sensor 26 detects the angular velocity generated in the operation device 20. The angular velocity sensor 26 detects at least the angular velocity around one axis, and preferably the angular velocities around three or six axes. With the angular velocities integrated together, the operation device 20 is capable of estimating the tilt (i.e., posture) of the operation device 20.

The capacitance sensor 27 detects the capacitance when the user touches or operates the operation device 20 held in a hand of the user. The capacitance sensor 27 is disposed on at least a part of a touch panel integrated with the display 28 and likely to be held by the user. The capacitance sensor 27 may detect, for example, a change in the capacitance due to deformation, a change in the capacitance occurring between an electrode and a human body (e.g., a fingertip), or a change in an electric field between a transmitting electrode and a receiving electrode when the electric field is generated with the transmitting electrode and the receiving electrode.

The display 28 displays a variety of information related to the image forming device 50 and a screen for receiving a variety of settings in a printing process, for example. The display 28 preferably includes a touch panel integrated with a flat panel display to receive operations performed on the screen by the user.

The wireless communication device 29 performs wireless communication between the operation device 20 and the image forming device 50. There are various types of wireless communication systems, including a wireless local area network (LAN) such as a wireless LAN conforming to wireless fidelity (Wi-Fi, registered trademark), a Bluetooth (registered trademark) network, and a mobile phone network. The wireless communication device 29 of the embodiment may employ any type of wireless communication system, as long as the communication system enables wireless communication.

When the operation device 20 is in the energy saving state, the power supply control device 30 supplies the power from the second power supply 24 to at least one of the angular velocity sensor 26 and the capacitance sensor 27. When the operation device 20 is in the standby state, the power supply control device 30 supplies the power from the second power supply 24 to all of the hardware components of the operation device 20. A power supply path 39 is a power supply line used to supply the power from the second power supply 24 to the entire operation device 20.

The image forming device 50 will now be described.

The image forming device 50 includes a CPU 41, a memory 42, an energy saving state cancellation control device 43, a hard disk drive (HDD) 44, a print device 45, and an energy saving state transition control device 46. The image forming device 50 controls the main unit 40 of the image forming apparatus 100 to form an image. For example, the image forming device 50 generates an image from print data, transports a recording medium (e.g., sheet) from a sheet feeding tray, and forms an image on the recording medium in accordance with a method such as the electrophotographic method or the inkjet method.

The CPU 41 executes programs stored in the memory 42 to provide an overall function of the image forming device 50 in cooperation with the other hardware components of the image forming device 50 illustrated in FIG. 2.

The memory 42 stores data such as image data of a print job and data temporarily used in data processing by the CPU 41. The memory 42 further stores the programs executed by the CPU 41. FIG. 2 illustrates one memory 42, but the image forming device 50 may include two types of memories: a volatile memory and a non-volatile memory. The HDD 44 is a non-volatile storage medium in which the image data of print jobs stored in the memory 42 is accumulated, and from which the accumulated image data is read.

The print device 45 is a function that performs an operation related to the printing process of the image forming device 50 described above. The print device 45 reads the image data stored in the memory 42 or the image data accumulated in the HDD 44, and prints the image data onto the recording medium. If the image forming apparatus 100 is an MFP, the image forming device 50 includes other devices than the print device 45 to provide functions such as the scanning function, the facsimile transmission and reception function, and the copying function.

Based on a request from the operation device 20, the energy saving state cancellation control device 43 returns the state of the print device 45 to the standby state from the energy saving state. Based on a request from the operation device 20, the energy saving state transition control device 46 transitions the state of the print device 45 to the energy saving state from the standby state. Most of the power consumption in the image forming device 50 is the power consumption by the print device 45, and thus the state of the print device 45 may be paraphrased as the state of the image forming device 50. In the energy saving state, power supply control is performed to supply power to some of the hardware components of the image forming device 50. The following description therefore includes wording such as “transitioning the state of the image forming device 50 to the energy saving state” and “returning the state of the image forming device 50 from the energy saving state.” The energy saving state cancellation control device 43 and the energy saving state transition control device 46 are implemented by a CPU or circuit.

The power supply device 60 will now be described.

The power supply device 60 includes a power supply shutdown control device 61 and the first power supply 62. In the standby state, the first power supply 62 converts alternate-current power supplied from an outlet 63 into direct-current power.

In the standby state or the energy saving state, the power supply shutdown control device 61 supplies the power from the first power supply 62 of the power supply device 60 to the image forming device 50 via a power supply path 47. Further, when the operation device 20 is attached to the main unit 40 of the image forming apparatus 100, the power supply shutdown control device 61 supplies the power to the second power supply 24 via the power supply path 48 and the charge control device 25. Further, based on a request from the operation device 20, the power supply shutdown control device 61 automatically shuts down the power supply from the first power supply 62 of the power supply device 60. Thereby, the power supply state of the image forming device 50 transitions to a power supply shutdown state. The power supply shutdown control device 61 is implemented by a CPU or circuit.

Functions of the image forming apparatus 100 will now be described.

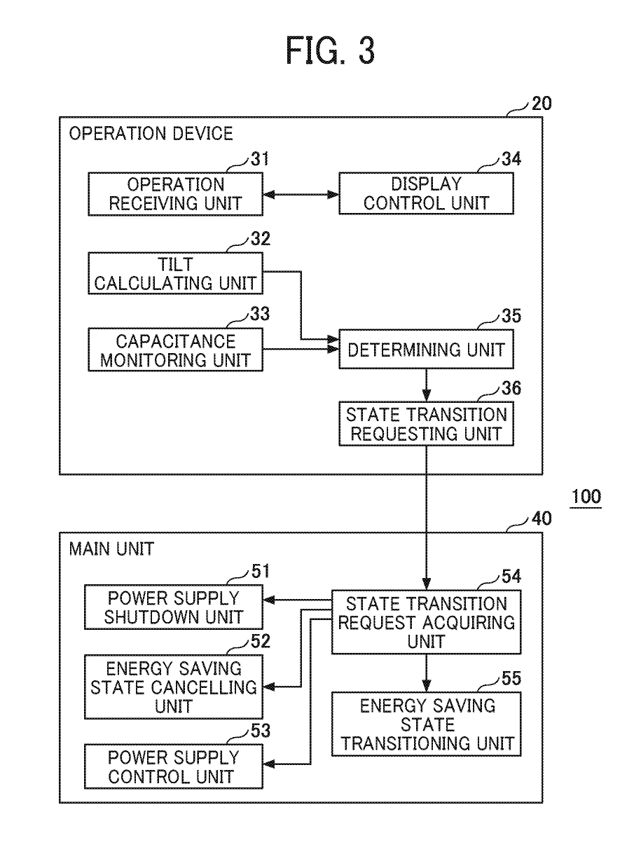

FIG. 3 is an exemplary functional block diagram illustrating functions of the image forming apparatus 100 of the embodiment in blocks. The operation device 20 includes an operation receiving unit 31, a tilt calculating unit 32, a capacitance monitoring unit 33, a display control unit 34, a determining unit 35, and a state transition requesting unit 36. These functions of the operation device 20 are functions or units implemented when the CPU 21 of the operation device 20 illustrated in FIG. 2 executes the programs stored in the memory 22, for example, and cooperates with the other hardware components of the operation device 20.

The operation receiving unit 31 receives a variety of operations performed on the operation device 20. For example, the operation receiving unit 31 receives print settings, such as the number of copies, the sheet size, and the selection between monochrome printing and color printing. The display control unit 34 displays, on the display 28 of the operation device 20, a screen for the user to operate the operation device 20. For example, the display control unit 34 displays a home screen for selecting an application and a print setting screen for receiving the above-described print settings.

The tilt calculating unit 32 integrates the angular velocities detected by the angular velocity sensor 26 to calculate the tilt of the operation device 20. The tilt of the operation device 20 may be paraphrased as the posture or direction of the operation device 20. The tilt calculating unit 32 calculates the tilt of the operation device 20, which changes when the user operates the operation device 20 held in a hand of the user. The tilt may be calculated as any of the yawing angle, the rolling angle, and the pitching angle, or may be calculated as at least two of these three angles.

The capacitance monitoring unit 33 monitors the capacitance detected by the capacitance sensor 27. For example, the capacitance monitoring unit 33 detects capacitance generated when the user touches parts of the opposite ends of the operation device 20, which are supposed to be held by the user, or the capacitance monitoring unit 33 detects a change in the capacitance generated by the touch. Alternatively, the capacitance monitoring unit 33 detects capacitance generated when the user touches the touch panel integrated with the display 28, or detects a change in the capacitance generated by the touch.

Based on the tilt calculated by the tilt calculating unit 32 and the capacitance monitored by the capacitance monitoring unit 33, the determining unit 35 determines whether or not the user has operated the operation device 20. In the embodiment, the determining unit 35 determines both operation and non-operation of the operation device 20.

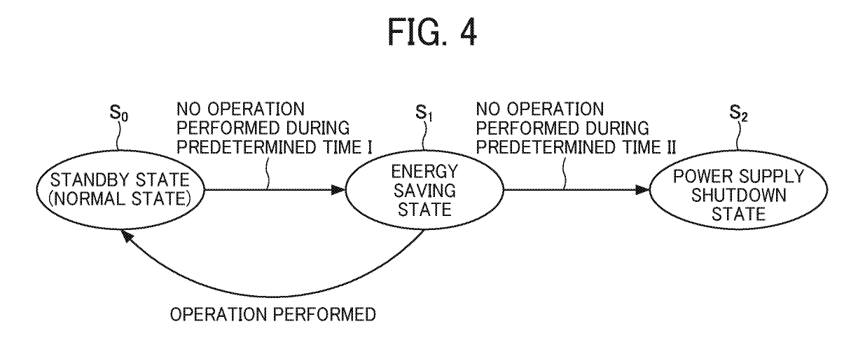

The state transition requesting unit 36 transmits, to the main unit 40 of the image forming apparatus 100, a request for transition of the power supply state of the image forming device 50, which will be described with FIG. 4. That is, the state transition requesting unit 36 requests the return from the energy saving state, the transition to the energy saving state, or the automatic power supply shutdown.

The main unit 40 of the image forming apparatus 100 includes a power supply shutdown unit 51, an energy saving state cancelling unit 52, a power supply control unit 53, a state transition request acquiring unit 54, and an energy saving state transitioning unit 55. These functions of the main unit 40 are functions or units implemented when the CPU 41 of the image forming device 50 illustrated in FIG. 2 executes the programs stored in the memory 42, for example, and cooperates with the hardware components of the image forming device 50 and the power supply device 60.

The state transition request acquiring unit 54 acquires (i.e., receives) the state transition request from the operation device 20. The state transition request acquiring unit 54 acquires the request for the return from the energy saving state, the transition to the energy saving state, or the automatic power supply shutdown described above.

The power supply shutdown unit 51 controls the power supply shutdown control device 61 to shut down the power supplied from the first power supply 62 to the image forming device 50 (i.e., change the power supply state of the image forming device 50). Thereby, the image forming device 50 transitions to the power supply shutdown state. The energy saving state transitioning unit 55 controls the energy saving state transition control device 46 to transition the image forming device 50 to the energy saving state (i.e., change the power supply state of the image forming device 50). That is, the power supply to the print device 45 of the image forming device 50 is limited. The energy saving state cancelling unit 52 controls the energy saving state cancellation control device 43 to return the image forming device 50 to the standby state (i.e., change the power supply state of the image forming device 50). That is, the entire image forming device 50 including the print device 45 starts to be supplied with power.

When the operation device 20 is attached to the image forming device 50, the power supply control unit 53 allows power supply to the second power supply 24 from the first power supply 62 via the power supply path 48. When the operation device 20 is not attached to the image forming device 50, the power supply control unit 53 stops the power supply to the second power supply 24 from the first power supply 62.

The state of the main unit 40 of the image forming apparatus 100 will be described. FIG. 4 is an exemplary diagram illustrating transitions of the state of the main unit 40 in the image forming apparatus 100 of the embodiment. The main unit 40 of the image forming apparatus 100, which includes the image forming device 50, takes one of three states: a standby state S₀, an energy saving state S₁, and a power supply shutdown state S₂.

The standby state S₀ refers to a state in which the operation by the user is waited for, and an operation such as a printing operation is immediately executable in response to the operation by the user. In the standby state S₀, partial power supply shutdown is not performed, and thus the power consumption is highest among the three states. The standby state S₀ may be referred to as the normal state.

The energy saving state S₁ refers to a state in which a part of the image forming device 50 is not supplied with power. For example, it is possible to make the power consumption lower than that in the standby state S₀ by stopping the power supply to the print device 45. Further, the power supply to the memory 42, the HDD 44, and the energy saving state transition control device 46 may be limited. Furthermore, the power supply to the CPU 41 may be limited.

The power supply shutdown state S₂ refers to a state in which the power supply to the image forming device 50 is completely shut down. In the power supply shutdown state S₂, therefore, the power consumption is lowest among the three states.

The standby state S₀ transitions to the energy saving state S₁ under a transition condition that the operation device 20 is not operated for a predetermined time I. The energy saving state S₁ transitions to the power supply shutdown state S₂ under a transition condition that the operation device 20 is not operated for a predetermined time II. The predetermined time I and the predetermined time II are not necessarily required to be different from each other, and may be the same. Each of the predetermined time I and the predetermined time II may be set to a desired value by the user on a screen displayed by the operation device 20.

Further, the energy saving state S₁ returns to the standby state S₀ under a return condition that the operation device 20 is operated again. This is because the operation of the operation device 20 is likely to be followed by the use of the image forming device 50.

The three states illustrated in FIG. 4 are illustrative, and the state of the image forming apparatus 100 may be divided into more states. In this case, when one state transitions to another state with less power consumption, the another state may be immediately next to the one state, or one or more states may be present between the one state and the another state. Further, any of the states may directly return to the standby state S₀, or the power supply state as the return destination may be limited in a certain state.

A first type of operation procedures of the image forming apparatus 100 will be described.

The following description will be given of respective procedures of the control of returning the image forming apparatus 100 from the energy saving state, the control of transitioning the image forming apparatus 100 to the energy saving state, and the automatic shutdown control of the image forming apparatus 100 based on the detection signal detected by the angular velocity sensor 26.

The return of the image forming apparatus 100 from the energy saving state will first be described.

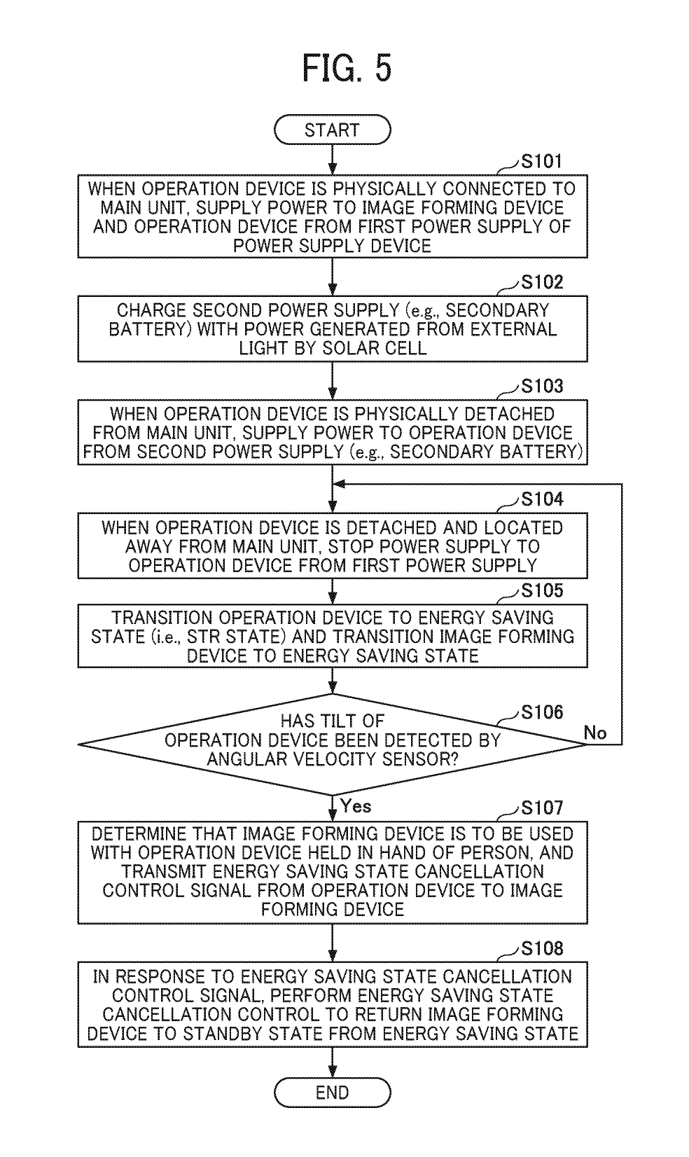

FIG. 5 is an exemplary flowchart illustrating an operation related to the control of returning the image forming apparatus 100 from the energy saving state.

When the operation device 20 is physically installed in (i.e., connected to) the main unit 40, the power supply control unit 53 supplies the power from the first power supply 62 of the power supply device 60 to the image forming device 50 and the operation device 20 (step S₁₀₁).

Further, the solar cell 23 of the operation device 20 charges the second power supply 24, such as a secondary battery, with the power generated from external light (step S₁₀₂).

When the operation device 20 is physically detached from the main unit 40, the second power supply 24, such as a secondary battery, supplies power to the operation device 20 (step S₁₀₃).

When the user detaches the operation device 20 from the main unit 40 and takes the operation device 20 to a place away from the main unit 40, the power supply control unit 53 stops the power supply from the first power supply 62 to the operation device 20 (step S₁₀₄). The solar cell 23 may continue to charge the second power supply 24.

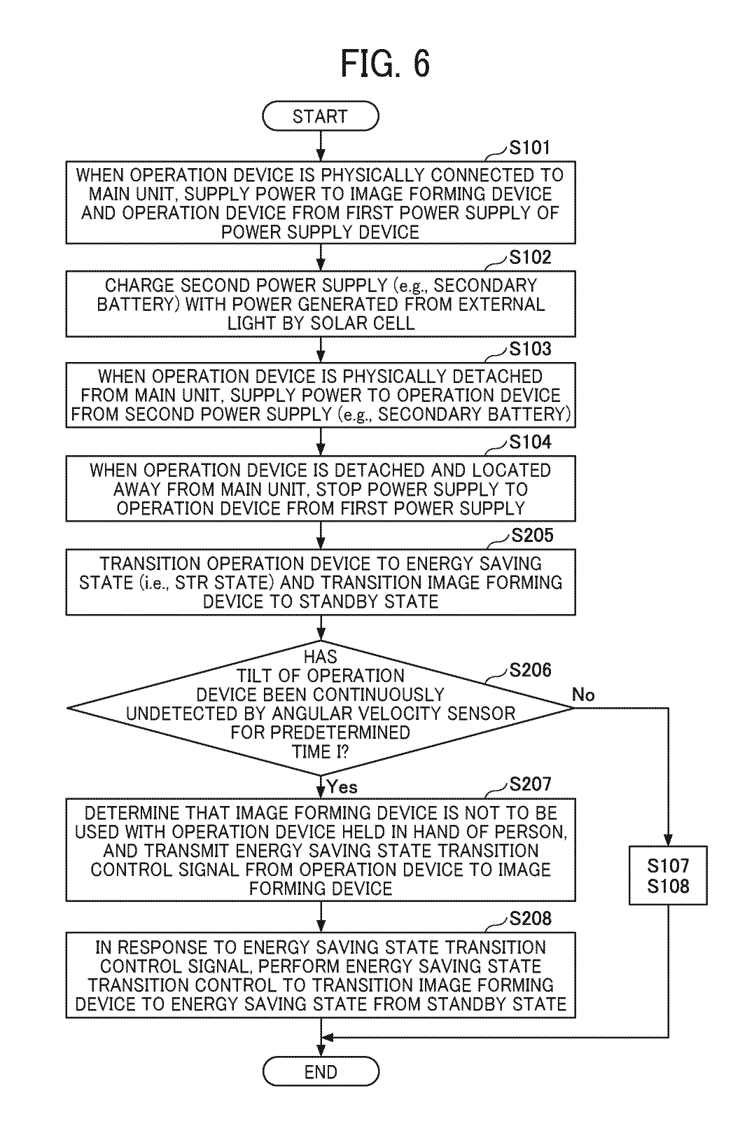

It is assumed here that, with the lapse of a predetermined time, the state of the operation device 20 has transitioned to an energy saving state called a suspend-to-random access memory state (i.e., STR state), and the state of the image forming device 50 has transitioned to the energy saving state S₁ (step S₁₀₅). The transition of the image forming device 50 to the energy saving state S₁ will be described later with FIG. 6. When the operation device 20 is in the energy saving state (i.e., STR state), the second power supply 24 supplies power to the angular velocity sensor 26 and the capacitance sensor 27.

Preferably, the tilt calculating unit 32 constantly calculates the tilt of the operation device 20 based on the detection signal of the angular velocity sensor 26. The determining unit 35 determines whether the tilt of the operation device 20 has changed (step S₁₀₆).

If the determination at step S₁₀₆ is No, the procedure returns to step S₁₀₄ to continue the energy saving state (i.e., STR state) of the operation device 20 and the energy saving state S₁ of the image forming device 50.

If the determination at step S₁₀₆ is Yes, the determining unit 35 of the operation device 20 determines that the user is to use the image forming device 50 with the operation device 20 held in a hand of the user. The state transition requesting unit 36 then transmits an energy saving state cancellation control signal to the image forming device 50 (step S₁₀₇).

In the image forming device 50, the state transition request acquiring unit 54 receives the energy saving state cancellation control signal, and the energy saving state cancelling unit 52 controls the energy saving state cancellation control device 43 to perform the control of returning the state of the image forming device 50 to the standby state S₀ from the energy saving state S₁ (step S₁₀₈).

The operation device 20 preferably retains the current power supply state of the image forming device 50. In this case, the operation device 20 retains information that the image forming device 50 has transitioned to the standby state S₀, therefore allowing the image forming device 50 to transition to the energy saving state S₁ when there is no physical change in the operation device 20. When the image forming device 50 is in the standby state S₀, the operation device 20 is capable of detecting, through communication, that the image forming device 50 is currently in the standby state S₀. Further, in this case, the operation device 20 retains information that the image forming device 50 has transitioned to the energy saving state S₁, therefore allowing the image forming device 50 to transition to the power supply shutdown state S₂ when there is no physical change in the operation device 20, or allowing the image forming device 50 to return to the standby state S₀ when there is a physical change in the operation device 20.

As described above, according to the image forming apparatus 100 of the embodiment, even when the image forming apparatus 100 is used with the operation device 20 detached from the image forming apparatus 100 and held in a hand of a person at a place away from the main unit 40 of the image forming apparatus 100, it is possible to perform the control of returning the main unit 40 of the image forming apparatus 100 from the energy saving state based on the request from the operation device 20 when the physical change of the operation device 20 is detected.

The transition of the image forming apparatus 100 to the energy saving state S₁ will be described.

FIG. 6 is an exemplary flowchart illustrating an operation related to the control of transitioning the image forming apparatus 100 to the energy saving state S₁. With FIG. 6, a description will be given of differences from FIG. 5. In FIG. 6, the processes of steps S₁₀₁ to S₁₀₄ may be similar to those in FIG. 5.

At step S₂₀₅, it is assumed that the state of the image forming device 50 has transitioned to the standby state S₀ through a process similar to that in FIG. 5, for example (step S₂₀₅). It is assumed here that the operation device 20 is in the energy saving state (i.e., STR state).

At step S₂₀₆, the determining unit 35 determines whether the tilt of the operation device 20 has been continuously unchanged for the predetermined time I (step S₂₀₆).

If the determination at step S₂₀₆ is No, a change in the tilt of the operation device 20 is detected. Therefore, the processes of steps S₁₀₇ and S₁₀₈ in FIG. 5 are executed. Since the main unit 40 is already in the standby state S₀, however, the execution of the processes of steps S₁₀₇ and S₁₀₈ does not change the power supply state of the image forming device 50.

If the determination at step S₂₀₆ is Yes, the determining unit 35 determines that the image forming device 50 is not to be used with the operation device 20 held in a hand of a person. The state transition requesting unit 36 then transmits an energy saving state transition control signal to the image forming device 50 (step S₂₀₇).

In the image forming device 50, the state transition request acquiring unit 54 receives the energy saving state transition control signal, and the energy saving state transitioning unit 55 causes the energy saving state transition control device 46 to perform the control of transitioning the state of the image forming device 50 from the standby state S₀ to the energy saving state S₁ (step S₂₀₈).

As described above, according to the image forming apparatus 100 of the embodiment, even when the image forming apparatus 100 is used with the operation device 20 detached from the image forming apparatus 100 and held in a hand of a person at a place away from the main unit 40 of the image forming apparatus 100, it is possible to perform the control of transitioning the main unit 40 of the image forming apparatus 100 to the energy saving state based on the request from the operation device 20 when the physical change of the operation device 20 is undetected.

The transition of the image forming apparatus 100 to the power supply shutdown state S₂ will be described.

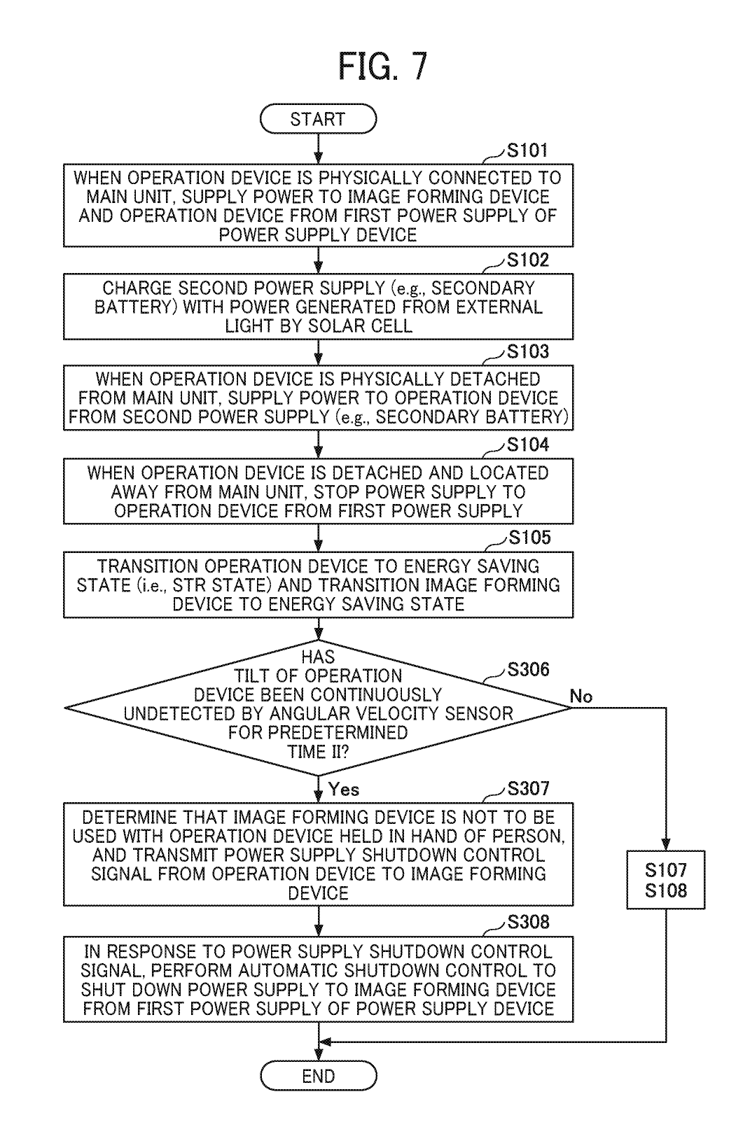

FIG. 7 is an exemplary flowchart illustrating an operation related to the power supply shutdown control of the image forming apparatus 100. With FIG. 7, a description will be given of differences from FIG. 5. In FIG. 7, the processes of steps S₁₀₁ to S₁₀₅ may be similar to those in FIG. 5.

At step S₃₀₆, the determining unit 35 determines whether the tilt of the operation device 20 has been continuously unchanged for the predetermined time II (step S₃₀₆).

If the determination at step S₃₀₆ is No, a change in the tilt of the operation device 20 is detected. Therefore, the processes of steps S₁₀₇ and S₁₀₈ in FIG. 5 are executed. Consequently, the image forming device 50 returns to the standby state S₀.

If the determination at step S₃₀₆ is Yes, the determining unit 35 determines that the image forming device 50 is not to be used with the operation device 20 held in a hand of a person. The state transition requesting unit 36 then transmits a power supply shutdown control signal to the image forming device 50 (step S₃₀₇).

In the image forming device 50, the state transition request acquiring unit 54 receives the power supply shutdown control signal, and the power supply shutdown unit 51 causes the power supply shutdown control device 61 to perform the automatic shutdown control to shut down the power supply from the first power supply 62 to the image forming device 50 (step S₃₀₈).

As described above, according to the image forming apparatus 100 of the embodiment, even when the image forming apparatus 100 is used with the operation device 20 detached from the image forming apparatus 100 and held in a hand of a person at a place away from the main unit 40 of the image forming apparatus 100, it is possible to perform the automatic power supply shutdown control of the main unit 40 of the image forming apparatus 100 based on the request from the operation device 20 when the physical change of the operation device 20 is undetected.

A second type of operation procedures of the image forming apparatus 100 will be described.

The following description will be given of respective procedures of the control of returning the image forming apparatus 100 from the energy saving state, the control of transitioning the image forming apparatus 100 to the energy saving state, and the automatic shutdown control of the image forming apparatus 100 based on the detection signal detected by the capacitance sensor 27.

The return of the image forming apparatus 100 from the energy saving state S₁ will first be described.

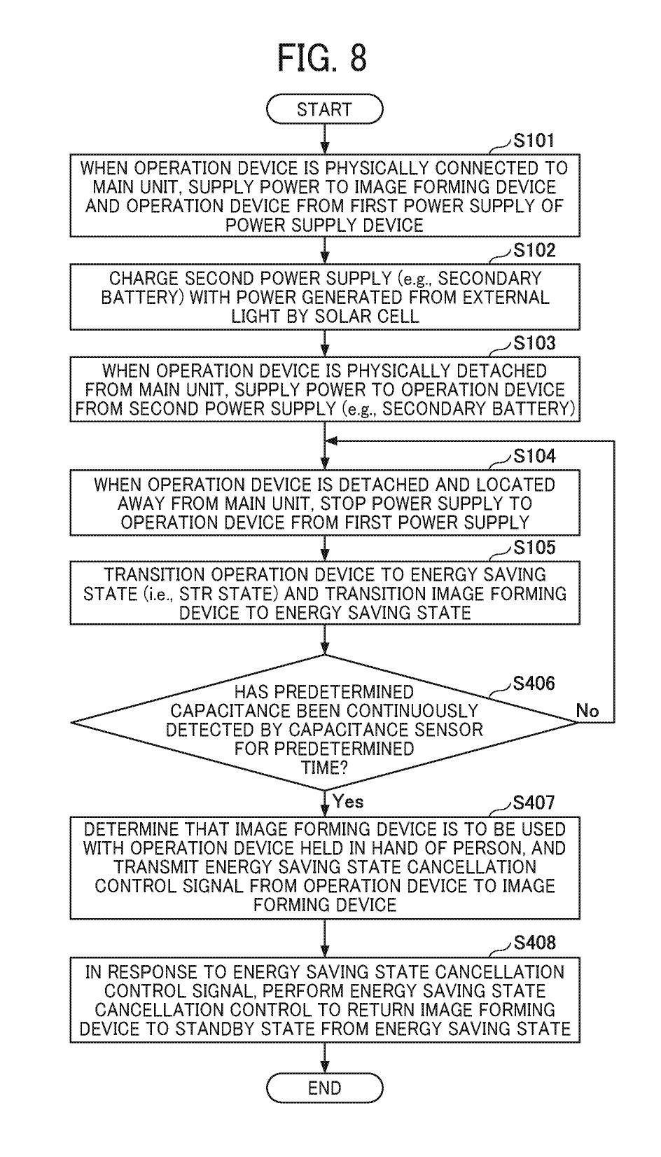

FIG. 8 is an exemplary flowchart illustrating an operation related to the control of returning the image forming apparatus 100 from the energy saving state S₁. With FIG. 8, a description will be given mainly of differences from FIG. 5. In FIG. 8, the processes of steps S₁₀₁ to S₁₀₅ are similar to those in FIG. 5.

At step S₄₀₆, based on the detection signal of the capacitance sensor 27, the capacitance monitoring unit 33 constantly detects a predetermined capacitance generated by the operation of the operation device 20 or a change in the predetermined capacitance. The determining unit 35 determines whether the predetermined capacitance or the change in the predetermined capacitance has been continuously detected for a predetermined time (step S₄₀₆). The predetermined capacitance is capacitance generated when the user holds the operation device 20. Further, the change in the capacitance is fluctuation in the capacitance caused by the operation of the operation device 20 by the user. The predetermined capacitance and the change in the predetermined capacitance are both determined by experiment.

If the determination at step S₄₀₆ is No, the procedure returns to step S₁₀₄ to continue the energy saving state (i.e., STR state) of the operation device 20 and the energy saving state S₁ of the image forming device 50.

If the determination at step S₄₀₆ is Yes, the determining unit 35 determines that the image forming device 50 is to be used with the operation device 20 held in a hand of the user. The state transition requesting unit 36 then transmits the energy saving state cancellation control signal to the image forming device 50 (step S₄₀₇).

In the image forming device 50, the state transition request acquiring unit 54 receives the energy saving state cancellation control signal, and the energy saving state cancelling unit 52 controls the energy saving state cancellation control device 43 to perform the control of returning the state of the image forming device 50 to the standby state S₀ from the energy saving state S₁ (step S₄₀₈).

The operation device 20 preferably retains the current power supply state of the image forming device 50. In this case, the operation device 20 retains information that the image forming device 50 has transitioned to the standby state S₀, therefore allowing the image forming device 50 to transition to the energy saving state S₁ when there is no physical change in the operation device 20. When the image forming device 50 is in the standby state S₀, the operation device 20 is capable of detecting, through communication, that the image forming device 50 is currently in the standby state S₀. Further, in this case, the operation device 20 retains information that the image forming device 50 has transitioned to the energy saving state S₁, therefore allowing the image forming device 50 to transition to the power supply shutdown state S₂ when there is no physical change in the operation device 20, or allowing the image forming device 50 to return to the standby state S₀ when there is a physical change in the operation device 20.

As described above, according to the image forming apparatus 100 of the embodiment, even when the image forming apparatus 100 is used with the operation device 20 detached from the image forming apparatus 100 and held in a hand of a person at a place away from the main unit 40 of the image forming apparatus 100, it is possible to perform the control of returning the main unit 40 of the image forming apparatus 100 from the energy saving state based on the request from the operation device 20 when the electrical change of the operation device 20 is detected.

The transition of the image forming apparatus 100 to the energy saving state S₁ will be described.

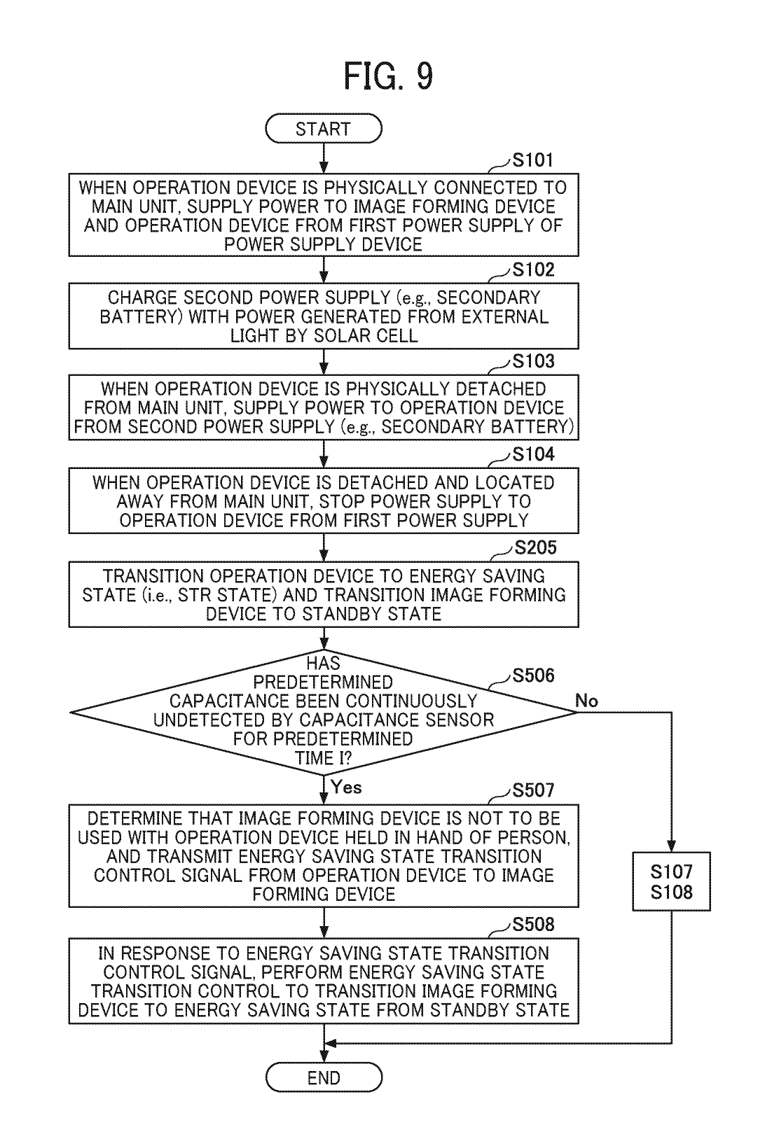

FIG. 9 is an exemplary flowchart illustrating an operation related to the control of transitioning the image forming apparatus 100 to the energy saving state S₁. With FIG. 9, a description will be given of differences from FIG. 5. In FIG. 9, the processes of steps S₁₀₁ to S₁₀₄ may be similar to those in FIG. 5.

At step S₂₀₅, it is assumed that the state of the image forming device 50 has transitioned to the standby state S₀ through a process similar to that in FIG. 8, for example (step S₂₀₅). It is assumed here that the operation device 20 is in the energy saving state (i.e., STR state).

At step S₅₀₆, the determining unit 35 determines whether a predetermined capacitance or a change in the predetermined capacitance has been continuously undetected for the predetermined time I (step S₅₀₆).

If the determination at step S₅₀₆ is No, the predetermined capacitance or the change in the predetermined capacitance is detected. Therefore, the processes of steps S₁₀₇ and S₁₀₈ in FIG. 5 are executed. Since the main unit 40 is already in the standby state S₀, however, the execution of the processes of steps S₁₀₇ and S₁₀₈ does not change the power supply state of the image forming device 50.

If the determination at step S₅₀₆ is Yes, the determining unit 35 determines that the image forming device 50 is not to be used with the operation device 20 held in a hand of a person. The state transition requesting unit 36 then transmits the energy saving state transition control signal to the image forming device 50 (step S₅₀₇).

In the image forming device 50, the state transition request acquiring unit 54 receives the energy saving state transition control signal, and the energy saving state transitioning unit 55 causes the energy saving state transition control device 46 to perform the control of transitioning the state of the image forming device 50 from the standby state S₀ to the energy saving state S₁ (step S₅₀₈).

As described above, according to the image forming apparatus 100 of the embodiment, even when the image forming apparatus 100 is used with the operation device 20 detached from the image forming apparatus 100 and held in a hand of a person at a place away from the main unit 40 of the image forming apparatus 100, it is possible to perform the control of transitioning the main unit 40 of the image forming apparatus 100 to the energy saving state based on the request from the operation device 20 when the electrical change of the operation device 20 is undetected.

The power supply shutdown control of the image forming apparatus 100 will be described.

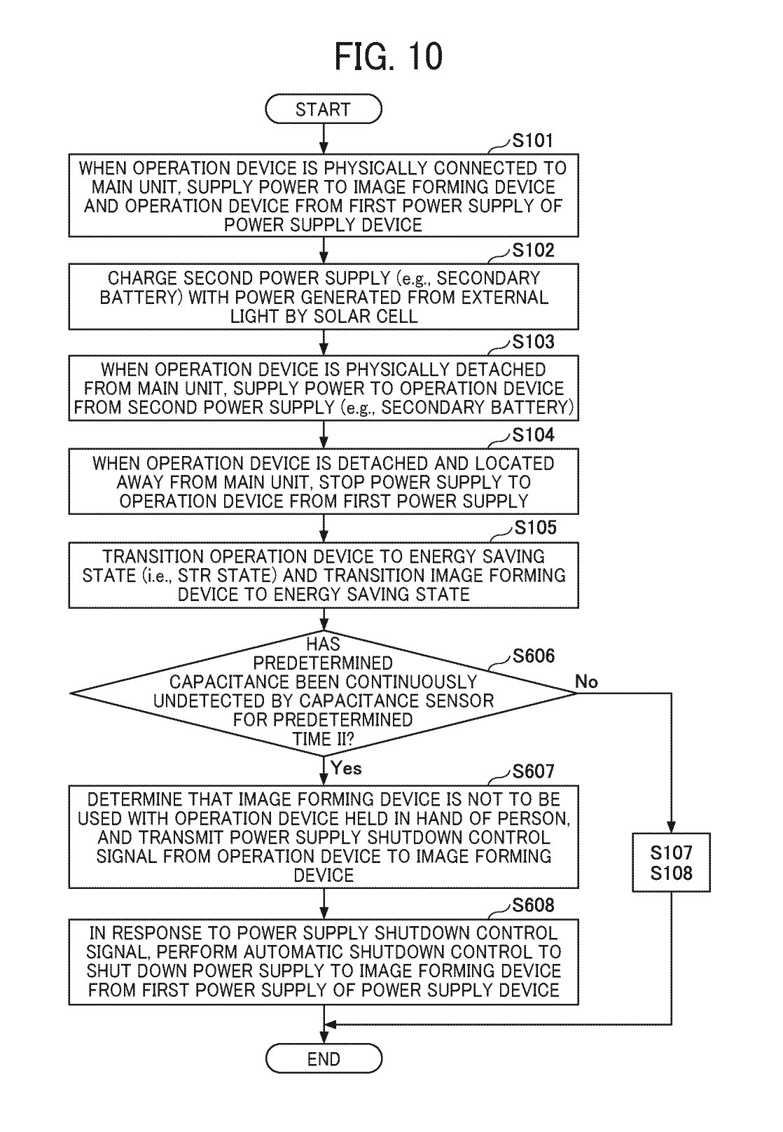

FIG. 10 is an exemplary flowchart illustrating an operation related to the power supply shutdown control of the image forming apparatus 100. With FIG. 10, a description will be given of differences from FIG. 5. In FIG. 10, the processes of steps S₁₀₁ to S₁₀₅ may be similar to those in FIG. 5.

At step S₆₀₆, the determining unit 35 determines whether a predetermined capacitance or a change in the predetermined capacitance has been continuously undetected for the predetermined time II (step S₆₀₆).

If the determination at step S₆₀₆ is No, the predetermined capacitance or the change in the predetermined capacitance is detected. Therefore, the processes of steps S₁₀₇ and S₁₀₈ in FIG. 5 are executed. Consequently, the image forming device 50 returns to the standby state S₀.

If the determination at step S₆₀₆ is Yes, the determining unit 35 determines that the image forming device 50 is not to be used with the operation device 20 held in a hand of a person. The state transition requesting unit 36 then transmits the power supply shutdown control signal to the image forming device 50 (step S₆₀₇).

In the image forming device 50, the state transition request acquiring unit 54 receives the power supply shutdown control signal, and the power supply shutdown unit 51 causes the power supply shutdown control device 61 to perform the automatic shutdown control to shut down the power supply from the first power supply 62 to the image forming device 50 (step S₆₀₈).

As described above, according to the image forming apparatus 100 of the embodiment, even when the image forming apparatus 100 is used with the operation device 20 detached from the image forming apparatus 100 and held in a hand of a person at a place away from the main unit 40 of the image forming apparatus 100, it is possible to perform the automatic power supply shutdown control of the main unit 40 of the image forming apparatus 100 based on the request from the operation device 20 when the electrical change of the operation device 20 is undetected.

Accordingly, it is possible to perform power control of the main unit of the information processing apparatus in accordance with the state of the operation device attachable to and detachable from the information processing apparatus.

In FIGS. 5 to 10, the physical change and the electrical change are determined separately. However, the physical change and the electrical change may be determined at the same time, for example.

Further, the foregoing embodiment uses the angular velocity sensor 26, for example, to detect the physical change of the operation device 20. However, an acceleration sensor may be used to detect the physical change of the operation device 20. In this case, at least a predetermined acceleration or velocity or a change in the predetermined acceleration or velocity is detected as the physical change. Further, the physical change of the operation device 20 may be detected with an azimuth sensor. The azimuth sensor detects the cardinal directions of the operation device 20, i.e., the angle (degrees) of the operation device 20 relative to north. In this case, a change in direction is detected as the physical change. As well as the change in direction, a change in temperature or pressure (i.e., holding force), for example, may be detected as the physical change.

Further, in the foregoing embodiment, the operation device 20 includes the determining unit 35. However, the main unit 40 including the image forming device 50 may include the determining unit 35.

Further, the operation device 20 is not limited to an information processing device attachable to and detachable from the image forming apparatus 100, and may be a general-purpose information processing device sold independently of the image forming apparatus 100. For example, the operation device 20 may be a tablet, a smartphone, or a personal computer (PC), for example.

Further, in the foregoing embodiment, description has been given of the image forming apparatus having a variable power supply state. The embodiment is also applicable to any other apparatus having a variable power supply state and including an operation device detachable from a main unit of the apparatus. For example, the embodiment is applicable to a video conference terminal, an electronic whiteboard, and a projector. The embodiment is further applicable to a game machine including a main unit and a remote controller that communicate with each other wirelessly, a television including an image receiver and a remote controller that communicate with each other wirelessly, an acoustic apparatus including a speaker usable as detached from a main unit of the acoustic apparatus, and an air-conditioner including a main unit and a remote controller that communicate with each other wirelessly. Each of these apparatuses has the function of the information processing apparatus.

The configuration examples in FIGS. 2 and 3 and other drawings are illustrated as divided in accordance with major functions of the image forming apparatus 100 to facilitate understanding of the processing of the image forming apparatus 100. The present invention is not limited by how the processing is divided into processing units or the names of the processing units. Further, the processing of the image forming apparatus 100 may be divided into a larger number of processing units, depending on the processing. Further, the processing of the image forming apparatus 100 may be divided such that one of the above-described processing units includes a plurality of processes.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An information processing system comprising:
an information processing apparatus; and
an operation device attachable to and detachable from the information processing apparatus,
the operation device including
a sensor configured to detect a physical change of the operation device, and
first circuitry configured to transmit a request for state transition to the information processing apparatus when the physical change of the operation device is detected by the sensor, and
the information processing apparatus including
second circuitry configured to acquire the request for state transition, and switch a power supply state of the information processing apparatus.

2. The information processing system of claim 1, wherein the physical change of the operation device is a physical change occurring in the operation device when the operation device is operated.

3. The information processing system of claim 1, wherein the physical change of the operation device is a change in a tilt or velocity of the operation device occurring when the operation device is operated.

4. The information processing system of claim 1, wherein in the operation device detached from the information processing apparatus, when the physical change of the operation device is detected by the sensor or when the physical change of the operation device is undetected by the sensor for a certain time, the first circuitry wirelessly transmits to the information processing apparatus a request for switching the power supply state of the information processing apparatus.

5. An information processing system comprising:
an information processing apparatus; and
an operation device attachable to and detachable from the information processing apparatus,
the operation device including
a sensor configured to detect an electrical change of the operation device, and
first circuitry configured to transmit a request for state transition to the information processing apparatus when the electrical change of the operation device is detected by the sensor, and
the information processing apparatus including
second circuitry configured to acquire the request for state transition, and switch a power supply state of the information processing apparatus.

6. The information processing system of claim 5, wherein the electrical change of the operation device is an electrical change occurring in the operation device when the operation device is operated.

7. The information processing system of claim 5, wherein the electrical change of the operation device is a change in capacitance occurring when the operation device is operated.

8. The information processing system of claim 5, wherein in the operation device detached from the information processing apparatus, when the electrical change of the operation device is detected by the sensor or when the electrical change of the operation device is undetected by the sensor for a certain time, the first circuitry wirelessly transmits to the information processing apparatus a request for switching the power supply state of the information processing apparatus.

9. The information processing system of claim 4, wherein the first circuitry wirelessly transmits to the information processing apparatus at least one of a request for transitioning the power supply state of the information processing apparatus to an energy saving state, a request for returning the power supply state of the information processing apparatus to a standby state from the energy saving state, and a request for transitioning the power supply state of the information processing apparatus to a power supply shutdown state.

10. A power supply state controlling method performed by an information processing system including an information processing apparatus and an operation device attachable to and detachable from the information processing apparatus, the power supply state controlling method comprising:
at the operation device, detecting a physical or electrical change of the operation device;
transmitting a request for state transition from the operation device to the information processing apparatus when the physical or electrical change of the operation device is detected; and
at the information processing apparatus, switching a power supply state of the information processing apparatus in response to the request for state transition.
